(19) United States
(12) Patent Application Publication
(10) Pub. No.: US 2024/0054614 A1
(43) Pub. Date: Feb. 15, 2024

(54) AUTO SAFE ZONE DETECTION

(71) Applicant: BRITISH TELECOMMUNICATIONS PUBLIC LIMITED COMPANY, London (GB)

(72) Inventors: Douglas WILLIAMS, London (GB); Ian KEGEL, London (GB); Brahim ALLAN, London (GB); Martin TRIMBY, London (GB); Luke PILGRIM, London (GB)

(21) Appl. No.: 18/553,640

(22) PCT Filed: Mar. 10, 2022
(86) PCT No.: PCT/EP2022/056229

§ 371 Date: Oct. 2, 2023

(30) Foreign Application Priority Data
Mar. 31, 2021 (GB) 2104554.7

(51) Int. Cl. G06T 5/50; G06T 3/40; G06T 7/11; G06V 10/44

(52) U.S. Cl. CPC G06T 5/50; G06T 3/40; G06T 7/11; G06V 10/44; G06V 2201/07; G06T 2207/20221

(57) ABSTRACT

Methods and systems for deciding whether, when, for how long, and/or where insertable image content will be displayed on top of a video presentation (i.e. existing image content) are disclosed. This can be for the imminent placement of insertable image content or a delayed placement of insertable image content. The decision making process depends upon the generation of a ‘cool map’. A cool map is a weighted map of the screen real estate that shows the areas that it would be practical to place insertable image content.

### PRIORITY CLAIM

The present application is a National Phase entry of PCT Application No. PCT/EP2022/056229, filed Mar. 10, 2022, which claims priority from GB Patent Application No. 2104554.7, filed Mar. 31, 2021, each of which is hereby fully incorporated herein by reference.

### TECHNICAL FIELD

Embodiments of the present disclosure described herein relate to methods and systems for automatically arranging insertable image content, e.g. graphics or picture-in-picture video over visual media.

### BACKGROUND

The arrangement of insertable image content, e.g. graphics, on top of visual media (e.g. subtitles on to a film) is usually determined through strict layout rules or through human intervention.

With fixed broadcast media where everyone sees the same thing, one design decision will serve all viewers equally well. But in an Object-Based Broadcasting (OBB) world, where TV presentation is personalized across one or more screens, the best place to render a particular graphic is not straightforward as different viewers' layouts may be different. In such circumstances simple rules are likely to be non-optimal.

Let us consider a televised presentation of a football match. The match is captured using multiple cameras and a match director decides which camera view to show on the screen at any one time. In addition to the camera footage, the screen will also show DOGS (Display On Screen Graphics). The DOGS may take many forms and may include:
a water-mark for the logo of the channel broadcasting the program;
a score clock may be shown as the match is played so that latecomers to the game can immediately see three letter acronyms of the teams playing and see the score and the time played (and/or possibly time remaining);
if a substitution occurs, a graphic will generally show the name of the players joining and leaving the field;
if the commentary team wish to promote another program or event that will soon be broadcast an In-Program Promotion Graphic may appear on the screen.

To summarize, today in sports broadcasting many graphics or other insertable image content may appear on the screen. The placement of these graphics is determined by designers who determine where each graphic should be located by defining a pixel-perfect position.

There are design conventions/guidelines including notions of ‘safe areas’ meaning areas on the screen where it will be safe to place insertable image content. Such safe areas were particularly important in the days of cathode ray tubes where different TV sets would crop the image differently. But even with flat screens different TVs can be set-up differently, sometimes with overscan or zoom which affects how much of the complete image can be seen on the screen. The Society of Motion Picture and Television Engineers (SMPTE) have defined safe areas and updated them for HDTV.

The design guidelines are used by graphics designers, directors and cameramen to help them to frame images appropriately. They tend to be defined for single screens and for screens of specific formats, particularly screens with a 16:9 aspect ratio for TV. As television and video programming is now shown on screens beyond the TV, including mobile phones, PCs, tablets, in head-mounted displays or even presented across multiple screens, the prescribed notion of a “safe zone” is less useful, particularly if local decisions can be made by viewers to “zoom in” to the 16:9 image to ensure it fills all the pixels on their off-format screen.

Some guidance is available e.g. eks.tv to help counter these foibles but they still amount to style guides and result in the definition of revised safe zones. They offer generalized rules that, if everyone in the video production chain plays by the rule, offer a one-size-fits-all (or nearly all) solution.

The word picture painted above describes a manageable situation. However if OBB develops such that viewers can choose to view additional graphics on their screens, such as widgets and optional elements, then the placement of these will need to be decided intelligently to prevent unnecessarily blocking important features of the football match. For example, optional elements may comprise a video of a person signing as an aid to those who are deaf, a live ticker keeping the viewer aware of other things of importance to them, or a twitter feed of the betting odds.

Formats for captions are standardized: CEA-608, CEA-708, Teletext and Open Captions. Within editing tools the text in captions can be changed, the size opacity and color of the caption can all be controlled.

An example that illustrates how different graphics can be used is shown in the 2-IMMERSE MotoGP Service Prototype Video available at www.youtube.com. This 3-minute video introduces the 2-IMMERSE MotoGP service prototype and shows all of its features in action. In particular, the commentary refers to the ability to adapt and scale the layout of on-screen graphics, e.g. “The ability to adapt the size and placement of graphics is a very simple and powerful capability.” However, it does not disclose or suggest how decisions about placement of graphics would be made.

Away from TV, HTML Responsive Web Design (Introduction and tutorial available at www.w3schools.com) is an established technique whose purpose is to ensure that the presentation of a website is optimal on all devices, independent of their screen size and aspect ratio. This is achieved by automatically hiding, shrinking or enlarging individual page elements, or choosing between alternative elements, based on the dimensions of the ‘viewport’ provided by the device. However, it does not detail or suggest any mechanism by which object placement would be made in conjunction with a cool map or equivalent.

2-IMMERSE: A platform for production, delivery and orchestration of Distributed Media Applications (paper and presentation in the IBC2018 conference available at www.ibc.org). This paper describes an overview of the 2-IMMERSE object-based broadcasting architecture, using the project's MotoGP trial as a case study. It therefore describes the key features of the MotoGP service prototype as well as the role of the Layout Service in managing and optimizing the presentation of the set of active DMApp Components across a set of participating devices. In particular, FIG. 3 “shows how, using the object-based broadcasting approach, the size and layout of the on-screen graphics can be adapted to better suit the context of TV size and to provide information suited to the specific needs of expert and novice viewers.”

The above-referenced paper has been updated (available at 2immerse.eu). The updated document identifies that screen types need to be recognized and layouts need to be chosen that are sympathetic to the characteristic of the device type (e.g. layout/portrait, interaction or not etc.). The disclosure does not use knowledge of system know how or a cool map for features of interest to guide the placement of objects. This document also identifies that different layout documents should be selected at different moments in the production. This layout selection is scripted and does not use a machine that uses a cool map to help decide where to put place graphics.

2-IMMERSE Deliverable D2.4 (Distributed Media Application Platform-Description of Second Release) (available at 2immerse.eu). This deliverable, and in particular section 6.2, describes how the MotoGP service prototype DMApp was implemented. It refers to the DMApp control component “applying TV scaling variable layout changes” and “adjusting the layout to fill the screen regardless of size/resolution”.

“Workflow support for live object based broadcasting” which can be found at ir.cwi.nl is a paper by Jack Jansen exploring the document formats that would support object based broadcasting. The paper focuses on requirement, specifically for the Timeline Document. The work focuses on how a timeline document should be structured. The work says little about where any media objects should be placed and does not mention or invoke a system that uses a cool map for features of interest to guide the placement of objects.

The BBC web page ‘A New View of the Weather: Forecaster5G, our Object-Based Weather Report’ can be found at www.bbc.co.uk. The web page says “[t]hese objects are sent independently to the end user's device, where they are rendered as a series of layers, each layer consisting of an HTML5 canvas, using our rendering engine. The composition of these layers, as well as the nature and location of the objects, is defined in a configuration file. On startup, the app requests the configuration file from a server. The server recognises the end user's device and chooses a configuration file suited to the particular needs of that device”. It does not mention or invoke a system that identifies a cool map or an equivalent of, to guide the location of the placement of the graphic.

DE102008056603B4 relates to measuring brand exposure (e.g. product placement). There is no disclosure or suggestion about the layout of placements. DE ‘603 is directed towards pattern matching to a known logo to identify brands and measure brand exposure. The method has no concern for occlusion or the potential for the placement of a new graphic to have a detrimental impact to the features of interest in the scene.

US20120218256A1 relates to placing graphics over 3D video using depth maps. US ‘256 discloses a method of generating a recommended depth value for use in displaying a graphics item over a three dimensional video. There is no disclosure or suggestion of the consideration of x and y coordinates, only z (depth). The decision made in US ‘256 is whether or not to show the graphic based on assessment of depth, rather than where (in x and y space) to place the graphic.

US9588663B2 relates to identifying ‘hotspots’ for embedding applications within a video. US ‘663 is a tool for tracking objects in a scene so they can be annotated with a hypercode. It is not a method for identifying good places to place graphics. The method has no concern for occlusion or the potential for the placement of the hypercode to have a detrimental impact to the features of interest in the scene.

US20030023971A1 relates to incorporating graphics and interactive triggers in a video stream. US ‘971 is a broadcast graphics system that can manually or automatically place graphics. The disclosure defines the term ‘hotspot’, but has no indication of how or why a hotspot is chosen. The method has no concern for occlusion or the potential for the placement of the graphic to have a detrimental impact to the features of interest in the scene.

### SUMMARY

The present disclosure addresses the above problem of insertable image content placement in an object-based-broadcasting (OBB) world by using knowledge of the screen “real-estate” in use and knowledge of which objects are already rendered to make better decisions about where to place a new object. Embodiments of the present disclosure provide automation of the decision process determining where insertable image content might be placed on the screen.

In view of the above, from a first aspect, the present disclosure relates to a method for determining placement of insertable image content over existing image content of a video frame, the method comprising receiving one or more video frames; analyzing the existing image content of the one or more frames to determine one or more portions thereof containing one or more features of interest; and placing the insertable image content over the existing image content of at least one of the one or more frames such that the placement of the insertable image content reduces obscuration of the one or more portions by the insertable image content.

The placement of insertable image content may relate to where, when and/or for how long the insertable image content is displayed, and/or the form of the insertable image content.

The insertable image content may be a graphic to be placed over the existing image content of the video frame. Alternatively, the insertable image content may be a picture-in-picture video to be positioned over the existing image content of the video frame.

The existing image content may be live video. For example, live video of an event, e.g. a sporting event or a news broadcast. Alternatively, the existing image content may be pre-recorded video. For example, pre-recorded video of an event, e.g. a sporting event or a news broadcast, or a television show. Alternatively, the existing image content may comprise an existing graphic. For example, a picture-in-picture video may be placed over an existing graphic, or an additional graphic may be placed over an existing graphic.

Several advantages are obtained from embodiments according to the above described aspect. For example, embodiments of the disclosure enable the automated placement of insertable image content such that they do not obscure features of interest. Embodiments of the disclosure are able to be performed locally at a viewer's device (e.g. TV, smartphone, tablet, etc.). This allows the process to be personalized to each individual viewer as the decisions described herein can be made locally at the viewer's device. This complements the OBB approach, where TV presentation is personalized across one or more screens, and in the future, where viewers may choose to view additional graphics on their screens, such as widgets and optional elements. Embodiments of the disclosure determine the optimum placement and form of insertable image content to be dynamically determined in four dimensions (three-dimensional space (x, y and z co-ordinates) and time (t)).

In some embodiments the at least one of the one or more frames overlaid by the insertable image content are to be imminently displayed to a viewer, i.e. the frames are for “immediate” display to the viewer. While broadcast video is always delayed to some extent as broadcasting takes finite time, from the perspective of the viewer and/or the broadcaster (whoever triggers the insertable image content placement) the insertable image content placement would appear immediate. This is advantageous where the video frames relate to live events, and the content is broadcast to viewers in real time. In such embodiments, the video frames may be treated in some way, this treatment may include downscaling the video, i.e., not using every frame of the video in order to speed up the process so that the content can still be broadcast in real time. In such embodiments, it may be determined that the insertable image content's optimum placement time is right now, i.e. there is an available “slot” for the insertable image content right away.

In some embodiments the at least one of the one or more frames overlaid by the insertable image content are to be displayed to a viewer at a later time. In such embodiments, it may be determined that a non-urgent insertable image content's optimum placement time is not imminent, i.e. there is not an available slot for the insertable image content right away, but the optimum placement may be in X frames (or seconds).

In some embodiments the analyzing of the existing image content comprises: determining locations of the one or more features of interest; dividing the existing image content into a plurality of sections; and associating, with each of the plurality of sections, a numeric value related to: (i) how frequently each section is co-located with at least one of the one or more features of interest; and (ii) a first score associated with each of the one or more features of interest indicating how important it is that each of the one or more features of interest is not obscured.

This is advantageous as it quantifies on a section by section basis, how important it is that that section is not obscured by the placement of insertable image content, taking into account the relative importance of the different on-screen features of interest. Features of interest may include features of the existing image content itself, i.e. a football or a player visible within the frame. Features of interest may alternatively or additionally include existing graphic objects already placed over the background image content, e.g. a live score graphic in the top left corner. Existing image content may be defined as including the image content of the video and any existing graphic objects already placed over the video (e.g. a live score graphic positioned in the top left corner throughout a football match).

In some embodiments a plurality of the numeric values associated with the plurality of sections comprise a weighted map displaying where placement of the insertable image content over the existing image content would be appropriate. Such a weighted map is referred to as a “cool map” throughout the description. The weighted map is a map of the screen “real estate” that shows the areas that it would be sensible to place insertable image content.

In some embodiments the method is performed for a plurality of successive frames which amount to a fixed duration, such that a weighted map relating to each successive frame is produced, thereby producing a plurality of weighted maps; and the method further comprises averaging the plurality of weighted maps over the fixed duration to produce a fixed duration weighted map displaying where placement of the insertable image content over the existing image content would be appropriate for the fixed duration.

This is advantageous as in practice, insertable image content needs to be placed over the existing image content for a fixed duration. For example, a graphic displaying the name of a player being substituted and their replacement may be displayed to a viewer for 10 seconds. Features of interest are likely to move around the screen in this time. Therefore, the frames within this fixed duration will need to be individually analyzed to produce a weighted map per frame displaying where placement of the insertable image content would be appropriate for each frame. These weighted maps are then averaged over the fixed duration to show, on average, where placement of the insertable image content would be most appropriate over the fixed duration.

In some embodiments the method further comprises: calculating, using the fixed duration weighted map, one or more second scores relating to one or more pairings of a graphic option selection and a placement option; selecting which of the one or more pairings should be used, based on the one or more second scores; and wherein the placing of the insertable image content is in accordance with the selected pairing.

This is advantageous as this allows for the insertable image content to be optimized for both placement position and graphic options relating to the insertable image content itself. Options relating to the insertable image content may comprise layout options, transparency options, and/or size options (potentially restricted by minimum sizes). For example, it may be determined that if the graphic has a name with a picture to the side, it cannot fit in a certain position which would otherwise have been a strong contender. However, if the graphic has a name with a picture below, it can fit in the certain position. Similarly, the placement position may be changed to suit a layout of the insertable image content. By using both placement position and options relating to the insertable image content itself as variables, the optimum combination can be found.

In some embodiments a set of fixed duration weighted maps is obtained for a current playback time code +n frames for a set of n values, wherein n is an integer between 0 and a value corresponding to the difference between a buffer duration and a desired duration of the insertable image content, such that each of the set of fixed duration weighted maps has a corresponding n value. The method further comprises: calculating, one or more second scores relating to one or more combinations of: (i) a graphic option selection, (ii) a placement option, and (iii) one or more n values; selecting which of the one or more combinations should be used, based on the one or more second scores; and the placing of the insertable image content is at a time code corresponding to the current playback time code +n frames and is in accordance with the selected combination.

This is advantageous as this enables delayed placement of insertable image content at an optimum time and enables the optimum placement for insertable image content to be calculated in four dimensions (three-dimensional space (x, y and z) and time (t)). For example, assuming a frame rate of 30 frames per second (fps), if the desired duration of the insertable image content is 5 seconds (equal to 150 frames), and the buffer duration is 20 seconds (equal to 600 frames), then n can be an integer between 0 and 450. A fixed duration weighted map may then be obtained for each of n=0, 1, 2, 3, 4, . . . , 449, 450 to produce a set of fixed duration weighted maps. The optimum combination of graphic option selection, placement option selection and n values can then be calculated. For example, it may be determined that the optimum combination is a transparent graphic with a name to the left of a picture, placed in the center of the lower third of the screen, over frames n=250 to n=400.

In some embodiments the selecting of which of the one or more pairings or combinations should be used is additionally based on one or more design rules which express where the insertable image content is conventionally placed. This is advantageous as design rules may be used to express conventions that are usually, but not always kept to. The design rules may be expressed as numerical problems that a machine can solve. For example, the notion that a graphic of a particular type should be placed in the bottom left corner “normally” may be expressed as the numerical rule based on a calculation of the ratio of the relevant cool scores. Continuing on from the example above, the optimum combination may then be determined to be a transparent graphic with a name to the left of a picture, placed in the bottom left corner of the screen, over frames n=250 to n=400, as positioning the graphic in the bottom left corner may have a cool score which was only slightly below the cool score of the graphic placed in the center of the lower third of the screen. Therefore, taking into account the preference of a design rule that such a graphic is usually placed in the bottom left corner, the optimum combination is updated.

In some embodiments the placing of the insertable image content is in response to a trigger. In some embodiments the placing of the insertable image content is imminent upon receiving the trigger. In some embodiments the placing of the insertable image content is scheduled for a later time upon receiving the trigger. In some embodiments the trigger is sent by a viewer of the existing image content. In some embodiments the trigger is sent by a broadcaster of the existing image content.

In some embodiments averaging the plurality of weighted maps comprises calculating a normalize sum.

In some embodiments, upon receiving the one or more video frames, the one or more video frames are downscaled. This is advantageous as, where the video content relates to a live event which is being broadcast live, the analysis needs to be undertaken in real time. By downscaling the video, the analysis time can be reduced.

In some embodiments each section of the content is a pixel. This is advantageous as the analysis has a high granularity, enabling precise placement of graphics. In some embodiments each section of the content is a group of pixels. This is advantageous as this reduces the processing time of the analysis which can be particularly important when broadcasting live events.

In some embodiments the placement of the insertable image content minimizes obscuration of the one or more portions by the insertable image content. In some embodiments, the insertable image content does not obscure the one or more portions.

From a second aspect, the present disclosure relates to a system for determining placement of insertable image content over existing image content of a video frame, the system comprising: a processor; and a memory including computer program code. The memory and the computer code configured to, with the processor, cause the system to perform the method of any of the embodiments relating to the first aspect described above.

From a third aspect, the present disclosure relates to a system for determining placement of insertable image content over existing image content of a video frame, the system comprising: a processor; an image analyzer arranged to: receive one or more video frames; and analyze the existing image content of the one or more frames to determine one or more portions thereof containing one or more features of interest; and a graphic placer arranged to: place the insertable image content over the existing image content of at least one of the one or more frames such that the placement of the insertable image content reduces obscuration of the one or more portions by the insertable image content.

The embodiments described above in relation to the method of the first aspect equally apply to the corresponding system of the third aspect described here.

In some embodiments the system further comprises a rules data store comprising: a scoring schema that associates one or more first scores with one or more features of interest within the content, the one or more first scores indicating how important it is that each of the one or more features of interest is not obscured; and the analyzing of the existing image content comprises: determining locations of the one or more features of interest; dividing the existing image content into a plurality of sections; and associating, with each of the plurality of sections, a numeric value related to: (i) how frequently each section is co-located with at least one of the one or more features of interest; and (ii) a first score associated with each of the one or more features of interest indicating how important it is that each of the one or more features of interest is not obscured.

In some embodiments a plurality of the numeric values associated with the plurality of sections comprise a weighted map displaying where placement of insertable image content over the existing image content would be appropriate.

In some embodiments the image analyzer is arranged to: analyze existing image content of a plurality of successive frames which amount to a fixed duration, such that a weighted map relating to each successive frame is produced, thereby producing a plurality of weighted maps; and average the plurality of weighted maps over the fixed duration to produce a fixed duration weighted map displaying where placement of insertable image content over the existing image content would be appropriate for the fixed duration.

In some embodiments the rules data store further comprises: a set of graphic options; a set of placement options for the insertable image content; and the system further comprises: a score calculator arranged to calculate, using the fixed duration weighted map, one or more second scores relating to one or more pairings of a graphic option from the set of graphic options and a placement option from the set of placement options; and a placement decision maker arranged to select which one of the one or more pairings should be used, based on the one or more second scores; and a trigger creator arranged to trigger the placement of the insertable image content by the graphic placer in accordance with the selected pairing.

In some embodiments the rules data store further comprises a set of design rules which express where the insertable image content is conventionally placed and the placement decision maker is arranged to select which of the one or more pairings should be used additionally based on one or more design rules from the set of design rules.

In some embodiments the image analyzer is arranged to obtain a set of fixed duration weighted maps for: a current playback time code +n frames for a set of n values, wherein n is an integer between 0 and a value corresponding to the difference between a buffer duration and a desired duration of the insertable image content, such that each of the set of fixed duration weighted maps has a corresponding n value; the rules data store further comprises: a set of graphic options; a set of placement options for the insertable image content; and the system further comprises: a score calculator arranged to calculate one or more second scores relating to one or more combinations of: (i) a graphic option from the set of graphic options, (ii) a placement option from the set of placement options, and (iii) one or more n values; a placement decision maker arranged to select which one of the one or more combinations should be used, based on the one or more second scores; a trigger creator arranged to trigger the placement of the insertable image content by the graphic placer at a time code corresponding to the current playback time code +n frames in accordance with the selected combination.

### BRIEF DESCRIPTION OF THE DRAWINGS

Embodiments of the disclosure will now be further described by way of example only and with reference to the accompanying drawings, wherein:

FIG. 1 is a flow chart illustrating embodiments of the present disclosure, in particular, the cool map generation process.

FIG. 2 is a flow chart illustrating embodiments of the present disclosure, in particular the imminent placement calculation.

FIG. 3 is a flow chart illustrating embodiments of the present disclosure, in particular the delayed placement calculation.

FIG. 4 illustrates embodiments of the present, in particular how different components of the system are arranged.

FIG. 5 illustrates an example of the present disclosure, in particular an analyzed frame of a football match where the features of interest have been highlighted and have associated scores.

FIG. 6 illustrates potential placement options for the above example frame, each placement option having a corresponding cool score.

FIG. 7 illustrates the final placement of a graphic for the above example.

FIG. 8 is a block diagram of a system according to an embodiment of the present disclosure.

### DESCRIPTION OF EMBODIMENTS

### Overview

Embodiments of the present disclosure are methods and systems for deciding whether, when, how long for, and/or where insertable image content will be displayed on top of a presentation (for example, the presentation may be a streaming of a live sports event). This can be for the imminent placement of insertable image content or a delayed placement of insertable image content. The decision making process depends upon the generation of a ‘cool map’ which is a map of the screen real estate that shows the areas that it would be cool (i.e. good/sensible) to place insertable image content.

For the detailed description, the insertable image content is referred to as a graphic. However, as described above, the insertable image content may be any insertable image content, e.g. a picture-in-picture video, widget and/or a graphic. The insertable image content itself may be dynamic or stationary.

Embodiments of the present disclosure are arranged such that the methods can be performed locally at a viewer's device (e.g. TV, smartphone, tablet, etc.). This allows the process to be personalized to each individual viewer as the decisions described herein can be made locally at the viewer's device. In other words, the method described herein is not for a centralized process, it is for personalized process. Where the methods are performed locally at a viewer's device, in the case of a live broadcast it would be necessary to create an additional buffer between video frames being received by the system and subsequently being presented to the viewer, to give the system the necessary time to calculate fixed duration cool maps by ‘looking ahead’ at video frames which have not yet been presented.

Embodiments of the present disclosure allow the optimum placement of graphics to be dynamically determined in four dimensions (three-dimensional space (x, y and z co-ordinates) and time (t)).

One or more of the following may be used as inputs into the process:
1. A scoring schema—a score associated with each feature of interest (e.g. the ball, the goal, the pitch, the crowd, existing graphics) indicating how important it is that the feature is not obscured, e.g. a ball may have a higher score than the crowd.
2. Graphic option selection—e.g. a graphic could be a “name super” comprising a picture and a name (e.g. of a player). The name super may appear in the following arrangements: Name to left of photo; Name to right of photo; Name under photo; Name above photo, etc. These could be graphic options selected when a name super is required. Graphic options may comprise possible orientation, layout, and/or size options for a graphic. The options are inputs to the decision making process.
3. Placement options—where on the screen the graphic is usually placed, e.g. the lower third of the screen. Options within this: centered; bottom left; or bottom right. These options will be defined precisely with reference to the screen real estate and graphic itself. The placement options are inputs to the decision making process.
4. Design rules—used to express conventions that are usually obeyed, e.g. this type of graphic is usually positioned in the bottom left corner. Placement should only deviate from convention if placing the graphic conventionally would be disadvantageous (e.g. obscuration of features of interest). These design rules may be expressed as numerical problems.

The existing image content (i.e. video) may be processed (e.g. downscaled) prior to being analyzed. Analysis determines locations of features of interest. This may be done on a periodic basis, e.g. for each frame of the video.

For each frame a cool map can be created. This associates, with each pixel location (or group of pixels), a numeric value that is related to how often each pixel location in a given frame is co-located with a feature of interest and to the score (which is taken from the scoring schema and shows how important it is that such a feature is not obscured by an on screen graphic) associated with the feature(s) of interest that may be co-located with the pixel location.

Graphics usually need to be on the screen for a specific duration. A fixed duration cool map is created by averaging the numeric values calculated for each pixel location for all the frames required to achieve for a particular duration.

A range of fixed duration cool maps (e.g. for 3 seconds, 5 seconds or 10 seconds) may be created and stored in a file store, buffer and/or database.

The two processes that calculate the imminent and delayed placements may involve one or more of the following components:
1. Cool score generation—a cool score is a value applied to the pairing of a particular graphic with the proposed placement of that graphic. Using the fixed duration cool map and a selected pairing of graphic and potential placement option, a score is calculated that provides some indication of the degree to which placement of an onscreen graphic in this location would obscure important features of interest for the viewer. Cool scores will be calculated for all the relevant pairings of graphic option and placement option and enable a decision to be made about which pairing of graphic and placement option should be used.
2. Placement decision maker—uses the cool scores, calculated for the relevant graphic and location pairings, optionally together with the design rules, to decide which pairing of graphic option and location option should be used.
3. Trigger for graphics placement—the placement decision may be enacted once the trigger to show a particular graphic is made. That trigger may be made by the broadcaster—who may wish to show the photograph and name of a scorer in a game of football for example, or by the viewer, who may select to show some additional graphical material over the video layer.

Various aspects and details of these principal components will be described below with reference to the Figures.

In more detail, consider the presentation, to at least one screen, of a live sports event watched by at least one viewer. On at least one occasion in the presentation of the live sports event, either the production team or the viewer may take an action that would result in the presentation of a graphic on top of the visual presentation of the live sports event. The intent may be that the graphic is shown imminently or at some time in the future.

As yet, there is no decision as to where on the visual presentation the graphic should be placed. Neither is there necessarily any decision as to when the graphic should appear.

Embodiments of the disclosure enable a decision to be made about whether, when, for how long, and/or where the graphic shall appear on the visual presentation of the live sports event. In other words, embodiments of the present disclosure allow the optimum placement of graphics to be dynamically determined in four dimensions (three-dimensional space (x, y and z co-ordinates) and time (t)).

There are two decision making processes, one for the imminent placement of graphics and the second for a delayed placement of a graphic. Both decision making processes depend upon the generation of a ‘cool map’, that is a map of the screen real estate that shows the areas that it would be cool (i.e. good/sensible) to place a graphic.

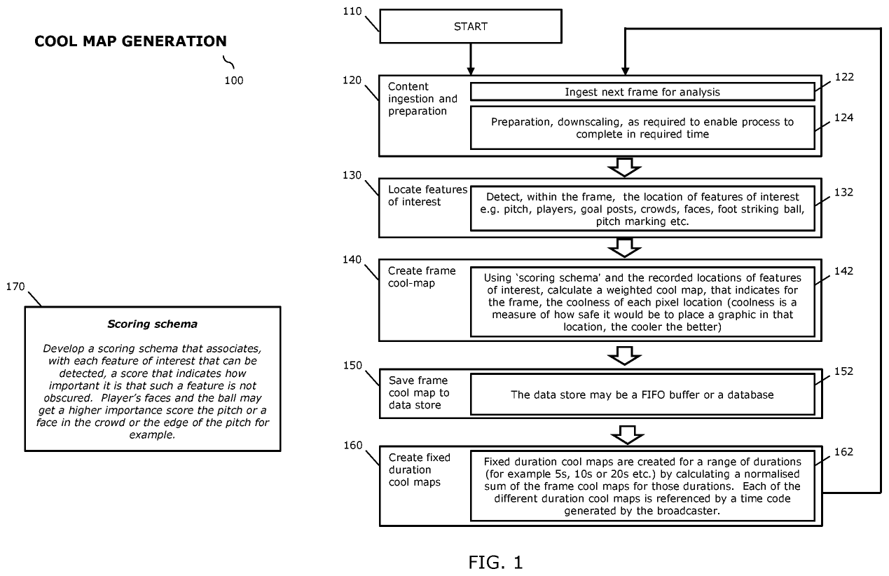

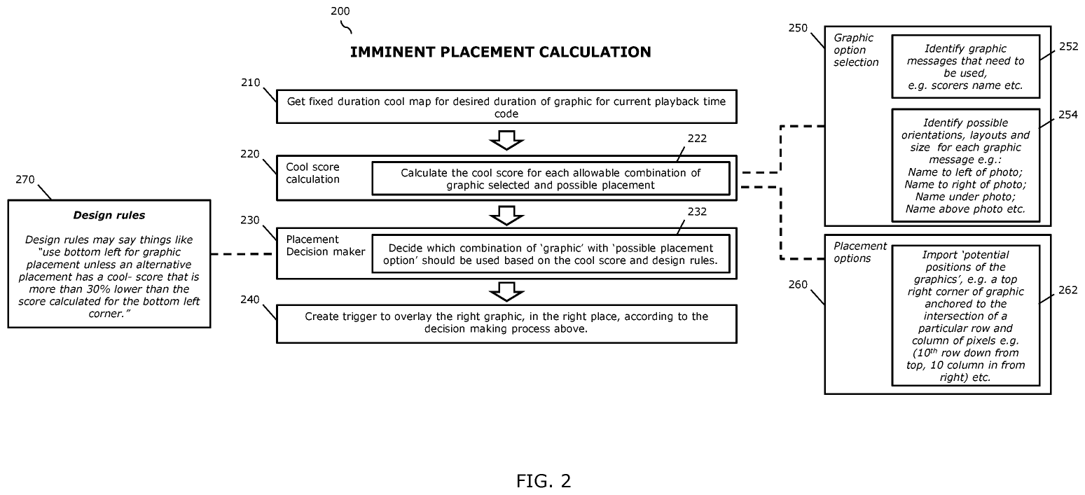

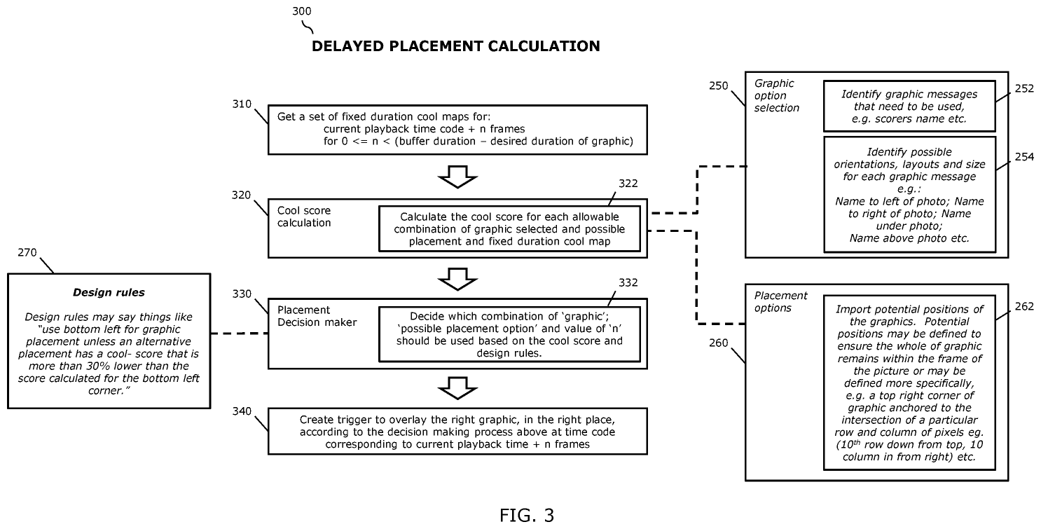

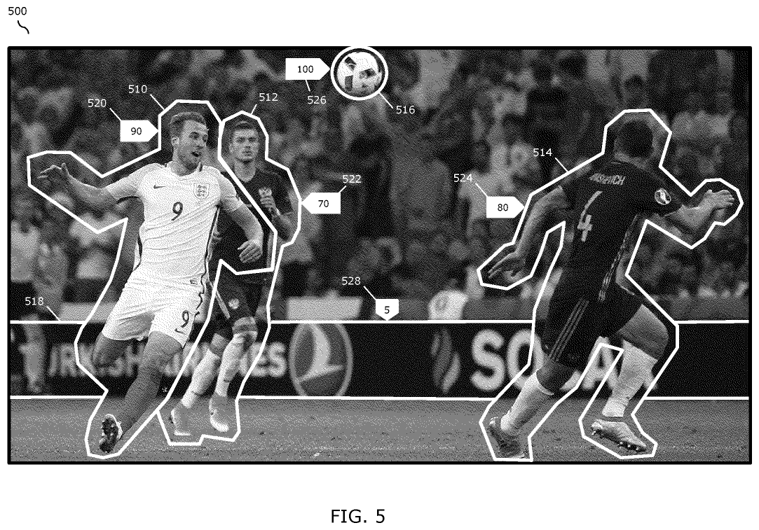

We describe three processes. Firstly, we describe the creation of a cool map with reference to FIG. 1. Secondly, we describe the decision process for imminent placement of a graphic with reference to FIG. 2. Thirdly, we describe the decision process for delayed placement of a graphic with reference to FIG. 3. FIGS. 5-7 demonstrate an example of the present disclosure on a frame of a football match.

These processes pre-suppose four inputs.
1. A scoring schema 170
2. Graphic option selection 250
3. Placement options 260
4. Design rules 270

### 1. A Scoring Schema 170

The scoring schema 170 associates, with each feature of interest in the visual presentation of the sports event that can be detected, a score that indicates how important it is that such a feature is not obscured. Examples of features that can be detected may include but are not be limited to: players, the ball, players' faces, the pitch, pitch line markings, the goal posts, the cross bar, the crowd, the advertising hoardings, the referee, and/or existing graphics.

Existing graphics, players' faces and the ball may get a higher importance score than the pitch or a face in the crowd or the advertising hoardings.

FIG. 5 illustrates an example of a frame of a football match 500 where examples of features of interest 510, 512, 514, 516, 518 have been highlighted and provided with example scores 520, 522, 524, 526, 528. In this example, the football 516 has been marked as a feature of interest and given a score 526 of 100 according to the scoring schema 170. In this example, the scores may range from 0 to 100, with 100 being the most important. In this example, the football 516 is the most important feature, as reflected by its score 526 of 100. The primary football player 510 has been marked as a feature of interest and given a score 520 of 90 according to the scoring schema 170. The secondary football player 514 has been marked as a feature of interest and given a score 524 of 80 according to the scoring schema 170. The third football player 512 has been marked as a feature of interest and given a score 522 of 70 according to the scoring schema 170. The advertising hoarding 518 has been marked as a feature of interest and given a score 528 of 5 according to the scoring schema 170. The advertising hoarding is therefore considered as a relatively unimportant feature of interest which may be obscured without negatively impacting the viewing of the frame. Other features of interest could be the referee, the crowd etc.

### 2. Graphic Option Selection 250

A graphic is shown for a purpose, for example a “name super” is used to show you the name and a picture of a particular person possibly a contributor, like a commentator, or a player. The name super comprises a picture and a name. The picture and the name could appear in different arrangements for example: Name to left of photo; Name to right of photo; Name under photo; Name above photo etc. These could be graphic options selected when a name super is required. Further graphic options may include varying the size and/or opacity of the graphic or parts of the graphic. For example, a semi-transparent graphic may be the best solution in some circumstances. The options 250 are inputs to the decision making process.

### 3. Placement Options 260

A graphic is usually placed in particular portion of the screen, for example the lower third. This is, by convention, the usual placement for a name super. Within the lower third three option may exist: centered; bottom left; or bottom right. These options will be defined precisely with reference to the screen real estate and graphic itself. The placement options 260 are inputs to the decision making process.

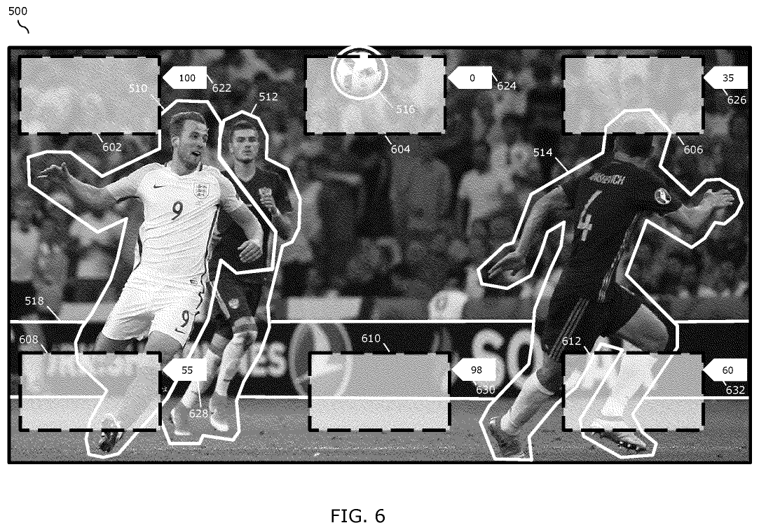

FIG. 6 illustrates an example of a frame of a football match 500 where examples of features of interest 510, 512, 514, 516, 518 have been highlighted, as in FIG. 5. FIG. 6 demonstrates potential placement options 602, 604, 606, 608, 610, 612 for a graphic, each placement option having an associated cool score 622, 624, 626, 628, 630, 632 providing some indication of the degree to which placement of an onscreen graphic in this location would obscure important features of interest for the viewer. Placement option 602 does not obscure important features of interest, and thus the cool score 622 for this option 602 may be 100, wherein a high cool score indicates that the placement option does not obscure important features of interest. Placement option 604 has a cool score 624 of zero. This reflects that this placement option 604 obscures an important feature of interest, namely the football 516. Placement option 606 has a cool score 626 of 35. This reflects that this placement option 606 obscures part of an important feature of interest 514. For similar reasons, placement options 608 and 612 have cool scores 628, 632 of 55 and 60, respectively. Placement option 610 has a cool score 630 of 98. This reflects that this placement option 610 only obscures the advertising hoarding 518, which is not a highly important feature of interest.

### 4. Design Rules 270

Design rules 270 may be used to express conventions that are usually, but not always kept to. A design convention may suggest that “Normally this type of graphic will be positioned in this part of the screen (a location at the bottom left corner say). Graphics should only appear in locations other than the bottom left corner, if placing them in this bottom left corner would affect the viewer's enjoyment of the game because (for example) placing graphics in that locations would lead to a number of features of interest being obscured by the graphic”.

The design rules 270 can be expressed as numerical problems that a machine can solve. For example, the notion that a graphic of a particular type should be placed in the bottom left corner “normally” may be expressed as the numerical rule base on a calculation of the ratio of the relevant cool scores (in this example it is assumed that a high cool score is good).

### IF

$$\frac{Cool score for the normal option}{Cool score for other options} > 0.8$$

choose normal option, ELSE choose option associated with the highest cool score.

It will be evident to the skilled person that the 0.8 value in the example above could be substituted for any suitable value, e.g. 0.1, 0.2, 0.3, 0.4, 0.5, 0.6, 0.7, 0.8, 0.9, 0.95.

In the example of FIGS. 5 and 6, the design rule for the graphic may be that it is normally displayed centrally in the lower third of the frame. In this case, the cool score for the normal option (i.e. option 610) would equal 98. Even for the highest scoring alternative option (i.e. option 602),

$$\frac{Cool score for the normal option}{Cool score for other options}$$

is equal to 0.98 (i.e. 98/100) and thus the chosen option would be option 610. Were the score for the normal option 75, then option 602 would be chosen as the better choice as 75/100 is less than 0.8.

Alternatively, the design rule for the graphic could be that it is normally displayed in the top left corner of the frame. In this case, option 602 would be the normal option and would be chosen as it has a cool score of 100.

Alternatively, the design rule for the graphic could be that it is normally displayed in the top right corner of the frame. In this case, option 606 would be the normal option. However, an alternative option (option 602) has a cool score of 100. Therefore, option 606 would not be chosen, despite being the “normal choice”, as

$$\frac{Cool score for the normal option}{Cool score for other options}$$

would equal 35/100, which is less than the example threshold of 0.8.

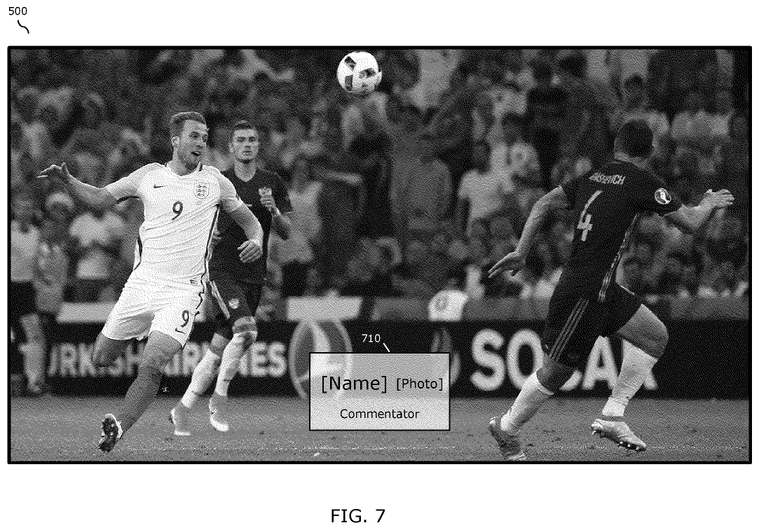

FIG. 7 shows the final placement of the graphic 710. In this example, the graphic may display the name and photo of a commentator. Such a graphic may be present for a fixed period of time, e.g. 5 seconds, 10 seconds, or more.

In cases where it is calculated to be suboptimal to place a graphic in its normal position (e.g. due to a conflict with a feature of interest), before resorting to moving the graphic away from its normal position, other options may be considered. Such options may involve considering whether the graphic could be reduced in size to overcome the conflict (this may be considered down to the limit of a predetermined minimum size as may be defined by the graphic options 250), and/or considering whether modifying the graphic to increase its transparency would overcome the conflict. If such options cannot sufficiently resolve the conflict, the graphic may be moved to a position other than its normal position.

### Cool Map Generation

We describe two decision systems, one for the imminent placement of a graphic and one for the delayed placement of a graphic. Both processes require the generation of a ‘cool map’ 100, which includes the following described in relation to FIG. 1.

### Content Ingestion and Preparation 120

The cool map generation 100 process starts 110 by ingesting the first frame of the content (e.g. video) for analysis 122. The content may be provided by a media content source. It may be a requirement for the process to be performed in real time, e.g. in the case of live events. To do so may require the video to be treated 124 in some way, this treatment may include downscaling the video, i.e., not using every frame of the video in order to speed up the process. The prepared video is then analyzed.

### Locating Features of Interest 130

This component analyses the video and determines the locations of features of interest. The component may include a range of different algorithm based detection processes 132 that determine the location, frame by frame, of features. Features of interest may include but are not limited to: players, the ball, players' faces, the pitch, pitch line markings, the goal posts, the cross bar, the crowd, the advertising hoardings, the referee, and existing on-screen graphics.

The location of features of interest may be determined on a periodic basis, possibly for each captured frame of video.

### Create Frame Cool Map 140

For each frame a cool map can be created. This associates, with each pixel location in a given frame, a numeric value that is related to: (i) whether or not each pixel location in the given frame is co-located with a feature of interest; and (ii) to the score associated with the feature(s) of interest that may be co-located with the pixel location. The score is taken from the scoring schema 170 which shows how important it is that such a feature is not obscured by an on screen graphic. Alternatively, instead of associating a numeric value with each pixel location, it may be advantageous to group pixels together and associate a numeric value with the location of each group of pixels. This would reduce the processing time required, but would reduce the granularity of the cool map. For simplicity, the rest of the process will be described assuming analysis for each pixel location. However, the process is equally applicable to groups of pixels.

In other words, a weighted cool map is calculated which indicates, for a given frame, the ‘coolness’ of each pixel location. ‘Coolness’ is a measure of how safe it would be to place a graphic in that location. The cooler the better.

The cool map for each frame is saved 150 to a datastore. The datastore may be a FIFO buffer or a database 152. The datastore may be local or cloud-based.

### Creation of Fixed Duration Cool Maps 160

Graphics usually need to be on the screen for a specific duration. In such cases, a fixed duration cool map may be created 160 by averaging the numeric values calculated for each pixel location for all the frames required to achieve for a particular duration. In more detail, fixed duration cool maps are created by calculating a normalized sum of the frame cool maps for those durations. Each of the different duration cool maps may be referenced by a time code generated by the broadcaster, e.g. a SMPTE timecode.

A range of fixed duration cool maps (e.g. for 3 seconds, 5 seconds, 10 seconds, 20 seconds, or 30 seconds) will be created and stored in a file store, buffer or database. It will be evident to the skilled person that a cool map for any fixed duration may be calculated. Fixed durations may range from 1 second to 60 seconds, 3 seconds to 30 seconds, 5 seconds to 10 seconds, or any combination thereof. Assuming a fixed frame rate, a fixed time duration corresponds to a fixed number of frames. For example, at a frame rate of 30 fps, a 10 second duration equals 300 frames.

The two processes that calculate the imminent 200 and delayed 300 placements involve the following components, described with references to FIGS. 2 and 3.

### Cool Score Generation 100, 220

The cool score is a value that is applied to the pairing of a particular graphic with the proposed placement of that graphic. A fixed duration cool map 210 is obtained for the desired duration of a graphic for the current playback time code (the code associated with the immediate frame). A selected pairing of a graphic 250 and a potential placement 260 option is used along with the fixed duration cool map to calculate a cool score 220 that provides an indication of the degree to which placement of that graphic in that placement option would obscure important features of interest for the viewer. Cool scores will be calculated for all the relevant pairings of graphic options 250 and placement options 260. The calculated cool scores enable a decision to be made about which pairing of graphic 250 and placement 260 option should be used. In some embodiments, a higher cool score indicates a better graphic and placement option. In other embodiments, a lower cool score indicates a better graphic and placement option.

### Placement Decision Maker 230

The placement decision maker 230 uses the cool scores, calculated for the relevant graphic and location pairings 220, optionally together with the design rules 270, to decide which pairing of graphic option and location option should be used.

### Trigger for Graphics Placement 240

The placement decision 230 will be enacted once the trigger to show a particular graphic is made. The trigger causes the chosen graphic to be overlaid in the chosen position, according to the decision making process described above. The trigger may be made by the broadcaster, who may wish to show the photograph and name of a scorer in a game of football for example, or by the viewer, who may select to show some additional graphical material over the video layer. In the case of imminent placement 200, upon receiving notification of the trigger, the graphic is imminently displayed in accordance with the decision.

### The System

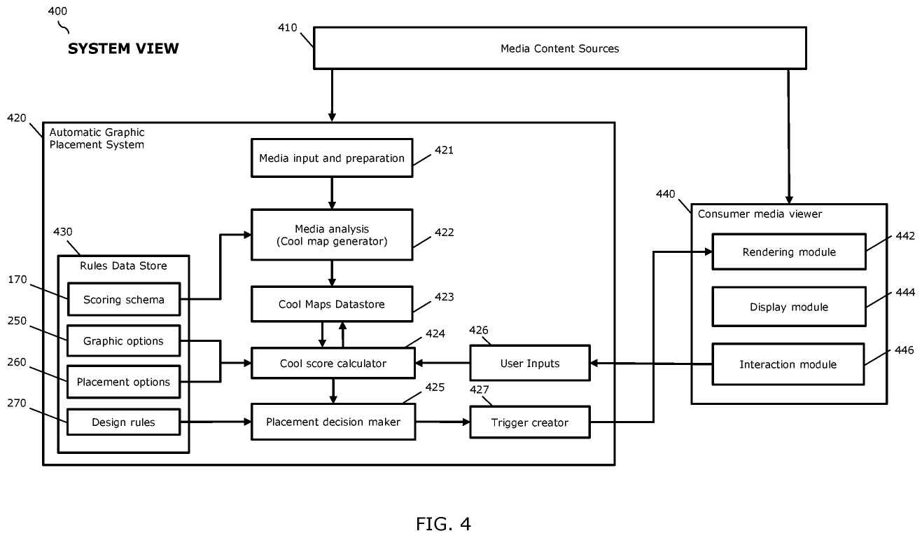

FIG. 4 illustrates the arrangement of the system 400 according to some embodiments of the disclosure. As described above, embodiments of the present disclosure are arranged such that the methods can be performed locally at a viewer's device (e.g. TV, smartphone, tablet, computer, etc.). This allows the process to be personalized to each individual viewer as the decisions described herein can be made locally at the viewer's device.

The system comprises an automatic graphic placement system 420 and a consumer media viewer 440 (e.g. a TV, smartphone, tablet, etc.). In some embodiments, the automatic graphic placement system 420 is located within the viewer's device (e.g. TV smartphone, tablet, etc.).

Media content sources 410 provide inputs of content (e.g. video frames) to the automatic graphic placement system 420 and the consumer media viewer 440. In embodiments where both the automatic graphic placement system 420 and the consumer media viewer 440 are located within the viewer's device, the media content sources 410 may deliver content to the viewer's device, which then in turn delivers the content to the automatic graphic placement system 420 and the consumer media viewer 440.

Media content sources 410 may provide content via TV platforms (e.g. set top boxes such as Virgin Media or Sky, or via an aerial platform such as Freeview), and/or via internet channels (e.g. streaming platforms such as Amazon Prime).

The content (i.e. media) is input 421 into the automatic graphic placement system 420 and prepared 421. Preparation 421 may comprise downscaling the video. The content is then analyzed 422 using the cool map generator process 100 as described above. The automatic graphic placement system 420 comprises a rules data store 430. The rules data store 430 may comprise scoring schema 170, graphic options 250, placement options 260, and design rules 270. The analysis 422 uses the scoring schema 170 as an input. As described above, cool maps may be saved 150 in a cool maps datastore 423. The datastore 423 may be a FIFO buffer or a database. The datastore 423 may be local or cloud-based. Cool score calculation 220, 320, as described above, is performed by a cool score calculator 424. The cool score calculator 424 uses the graphic options 250 and the placement options 260 as inputs. The cool score calculator 424 may also take user inputs 426. The cool score calculator 424 may access data saved in the cool maps datastore 423 and/or may save data (e.g. cool maps scores) to the datastore 423. Placement decision 230, 330, as described above, is performed by a placement decision maker 425. The placement decision maker 425 may use the design rules 270 as an input. The trigger creation 240, 340, as described above, is performed by a trigger creator 427.

The consumer media viewer 440 comprises a rendering module 442, a display module 444, and an interaction module 446. The interaction module 446 allows a viewer to provide inputs 426 to the automatic graphic placement system 420. For example, the viewer may have requested the additional graphic, and so will have provided inputs as to which graphic they want. In some arrangements, the viewer may trigger the placement of the graphic. In such arrangements, user inputs would also be input into the trigger creator 427. Upon instruction from the trigger creator 427, the rendering module 442 renders the graphics in line with the decision made by the placement decision maker 425. The media content and the graphics are then displayed to the viewer by the display module 444.

In some embodiments, instead of or in addition to the viewer providing user inputs via the consumer media viewer 440, a broadcaster may provide user inputs before the media is sent to the consumer media viewer 440.

Defining ‘capture time’ as the time at which events occur during the live football match, and ‘playback time’ as the time at which the same video is rendered on the consumer media viewer 440, for our ‘imminent placement’ option, we have two scenarios:
1. If the trigger is created by the consumer media viewer 440, the graphic will be displayed at a time code corresponding to the current playback time—so ‘immediate’ or ‘imminent’ from the viewer's perspective.
2. If the trigger is created by the broadcaster, the graphic will be displayed at a time code corresponding to the current capture time. In this case, the cool score calculation process would need to be delayed because, at the point at which the broadcaster creates the trigger, the frames needed for the calculation have not yet been captured.

In the case of delayed placement 300, a similar process to the imminent placement 200 described above is followed. However, in the case of delayed placement 300, the fixed duration cool map is obtained 310 for the current playback time code +n frames, where 0≤n< (buffer duration—desired duration of graphic). The cool score calculation 320 is performed in the same manner as the imminent placement 200 described above. The placement decision maker 330 decides which combination of graphic 250, possible placement option 260, and one or more n values should be used, based on the cool score 320 and design rules 270. The trigger 340 causes the chosen graphic to be overlaid in the chosen position, according to the decision making process above at a time code corresponding to the current playback time +n frames.

### The Computer System

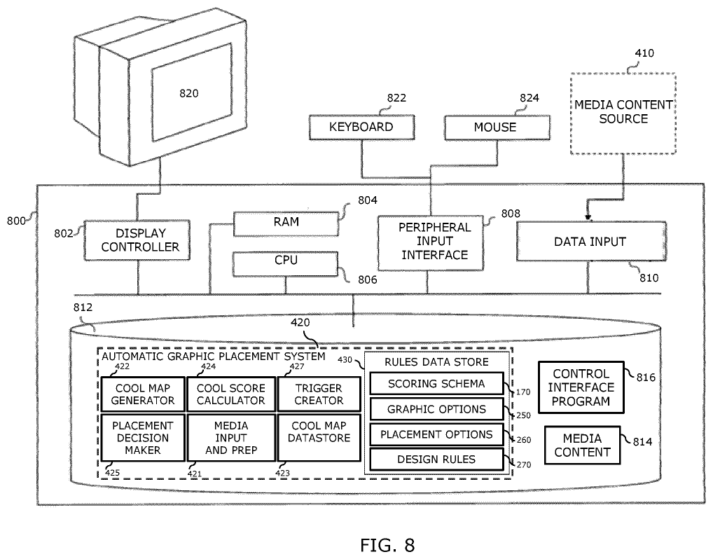

An example of a computer system used to perform embodiments of the present disclosure is shown in FIG. 8.

FIG. 8 is a block diagram illustrating an arrangement of a system according to an embodiment of the present disclosure. Some embodiments of the present disclosure are designed to run on general purpose desktop or laptop computers. Alternatively, some embodiments are designed to run on TV devices, such as for example so called ‘smart’ TVs, or in set-top boxes (STBs). According to an embodiment, a computing apparatus 800 is provided having a central processing unit (CPU) 806, and random access memory (RAM) 804 into which data, program instructions, and the like can be stored and accessed by the CPU. The apparatus 800 is provided with a display screen 820, and may be provided with input peripherals in the form of a keyboard 822, and mouse 824. Keyboard 822, and mouse 824 communicate with the apparatus 800 via a peripheral input interface 808. Other embodiments may include remote control handsets arranged to control the apparatus; such may especially be the case when the apparatus is a smart TV or set top box. Similarly, a display controller 802 is provided to control display 820, so as to cause it to display images under the control of CPU 806. Media content 814 from a media content source 410 can be input into the apparatus and stored via data input 810. In this respect, apparatus 800 comprises a computer readable storage medium 812, such as a hard disk drive, writable CD or DVD drive, zip drive, solid state drive, USB drive or the like, upon which media content 814 can be stored. Alternatively, the media content 814 could be stored on a web-based platform, e.g. a database, and accessed via an appropriate network. Computer readable storage medium 812 also stores various programs, which when executed by the CPU 806 cause the apparatus 800 to operate in accordance with some embodiments of the present disclosure.

In particular, a control interface program 816 is provided, which when executed by the CPU 806 provides overall control of the computing apparatus, and in particular provides a graphical interface on the display 820, and accepts user inputs using the keyboard 822 and mouse 824 by the peripheral interface 808. The control interface program 816 also calls, when necessary, other programs to perform specific processing actions when required. For example, an automatic graphic placement system program 420 is provided which is able to operate on media content 814, which may be indicated by the control interface program 816. The automatic graphic placement system program 420 comprises a cool map generator 422, a cool score calculator 424, a trigger creator 427, a placement decision maker 425, a media input and preparation program 421, a cool map datastore 423, and a rules data store 430. The rules data store 430 comprises scoring schema 170, graphic options 250, placement options 260, and design rules 270. The operation of the automatic graphic placement system program 420 is described in detail above.

The detailed operation of the computing apparatus 800 will now be described. Firstly, a user launches the control interface program 816. The control interface program 816 is loaded into RAM 804 and is executed by the CPU 806. The user then launches the automatic graphic placement system program 420, alternatively, the automatic graphic placement system program 420 may be configured to run automatically. The automatic graphic placement system program 420 may be configured to run automatically upon receiving content 814 from the media content sources 410. Alternatively, the automatic graphic placement system program 420 may be configured to run upon instructions received from the viewer. The automatic graphic placement system program 420 then operates as described previously.

Various modifications whether by way of addition, deletion, or substitution of features may be made to above described embodiment to provide further embodiments, any and all of which are intended to be encompassed by the appended claims.

1. A method for determining placement of insertable image content over existing image content of a video frame, the method comprising:
receiving one or more video frames;
analyzing the existing image content of the one or more video frames to determine one or more portions of the existing image content containing one or more features of interest; and
placing the insertable image content over the existing image content of at least one of the one or more video frames such that a placement of the insertable image content reduces obscuration of the one or more portions by the insertable image content.

2. The method according to claim 1, wherein the at least one of the one or more video frames overlaid by the insertable image content are to be imminently displayed to a viewer.

3. The method according to claim 1, wherein the at least one of the one or more video frames overlaid by the insertable image content are to be displayed to a viewer at a later time.

4. The method according to claim 1, wherein the analyzing of the existing image content comprises:
determining locations of the one or more features of interest;
dividing the existing image content into a plurality of sections; and
associating, with each of the plurality of sections, a numeric value related to:
how frequently each section is co-located with at least one of the one or more features of interest; and
a first score associated with each of the one or more features of interest indicating how important it is that each of the one or more features of interest is not obscured.

5. The method according to claim 4, wherein a plurality of the numeric values associated with the plurality of sections comprise a weighted map displaying where placement of the insertable image content over the existing image content would be appropriate.

6. The method according to claim 5, wherein the method is performed for a plurality of successive frames which amount to a fixed duration, such that a weighted map relating to each successive frame is produced, thereby producing a plurality of weighted maps; and the method further comprises averaging the plurality of weighted maps over the fixed duration to produce a fixed duration weighted map displaying where placement of the insertable image content over the existing image content would be appropriate for the fixed duration.

7. The method according to claim 6, further comprising:
calculating, using the fixed duration weighted map, one or more second scores relating to one or more pairings of a graphic option selection and a placement option;
selecting which of the one or more pairings should be used, based on the one or more second scores; and
wherein the placing of the insertable image content is in accordance with the selected pairing.

8. The method according to claim 6, wherein a set of fixed duration weighted maps is obtained for a current playback time code +n frames for a set of n values, wherein n is an integer between 0 and a value corresponding to a difference between a buffer duration and a desired duration of the insertable image content, such that each of the set of fixed duration weighted maps has a corresponding n value; and wherein the method further comprises:
calculating, one or more second scores relating to one or more combinations of: a graphic option selection, a placement option, one or more values of n;
selecting which of the one or more combinations should be used, based on the one or more second scores; and
wherein the placing of the insertable image content is at a time code corresponding to the current playback time code +n frames and is in accordance with the selected combination.

9. The method according to claim 7, wherein the selecting of which of the one or more pairings or combinations should be used is additionally based on one or more design rules which express where the insertable image content is conventionally placed.

10. The method according to claim 1, wherein the placing of the insertable image content is in response to a trigger.

11. The method according to claim 10, wherein the placing of the insertable image content is imminent upon receiving the trigger.

12. The method according to claim 10, wherein the placing of the insertable image content is scheduled for a later time upon receiving the trigger.

13. The method according to claim 10, wherein the trigger is sent by a viewer or a broadcaster of the existing image content.

14. The method according to claim 6, wherein averaging the plurality of weighted maps comprises calculating a normalized sum.

15. The method according to claim 1, wherein upon receiving the one or more video frames, the one or more video frames are downscaled.

16. The method according to claim 4, wherein each section of the existing image content is a pixel or a group of pixels.

17. The method according to claim 1, wherein the placement of the insertable image content minimizes obscuration of the one or more portions by the insertable image content.

18. A system for determining placement of insertable image content over existing image content of a video frame, the system comprising:
a processor; and
a memory including computer program code, the memory and the computer code configured to, with the processor, cause the system to perform the method of claim 1.

19. A system for determining placement of insertable image content over existing image content of a video frame, the system comprising:
a processor;
an image analyzer arranged to:
receive one or more video frames; and
analyze the existing image content of the one or more video frames to determine one or more portions of the existing image content containing one or more features of interest; and
a graphic placer arranged to:
place the insertable image content over the existing image content of at least one of the one or more video frames such that a placement of the insertable image content reduces obscuration of the one or more portions by the insertable image content.

20. The system according to claim 19, wherein the system further comprises:
a rules data store comprising a scoring schema that associates one or more first scores with one or more features of interest within the existing image content, the one or more first scores indicating how important it is that each of the one or more features of interest is not obscured;
and wherein the analyzing of the existing image content comprises:
determining locations of the one or more features of interest,
dividing the existing image content into a plurality of sections, and
associating, with each of the plurality of sections, a numeric value related to:
how frequently each section is co-located with at least one of the one or more features of interest; and
a first score associated with each of the one or more features of interest indicating how important it is that each of the one or more features of interest is not obscured.

21. The system of claim 20, wherein a plurality of the numeric values associated with the plurality of sections comprise a weighted map displaying where placement of insertable image content over the existing image content would be appropriate.

22. The system according to claim 21, wherein the image analyzer is arranged to:
analyze existing image content of a plurality of successive frames which amount to a fixed duration, such that a weighted map relating to each successive frame is produced, thereby producing a plurality of weighted maps; and
average the plurality of weighted maps over the fixed duration to produce a fixed duration weighted map displaying where placement of insertable image content over the existing image content would be appropriate for the fixed duration.

23. The system according to claim 22, wherein:
the rules data store further comprises:
a set of graphic options, and
a set of placement options for the insertable image content; and the system further comprises:
a score calculator arranged to calculate, using the fixed duration weighted map, one or more second scores relating to one or more pairings of a graphic option from the set of graphic options and a placement option from the set of placement options,
a placement decision maker arranged to select which one of the one or more pairings should be used, based on the one or more second scores; and
a trigger creator arranged to trigger the placement of the insertable image content by the graphic placer in accordance with the selected pairing.

24. The system according to claim 23, wherein the rules data store further comprises a set of design rules which express where the insertable image content is conventionally placed and the placement decision maker is arranged to select which of the one or more pairings should be used additionally based on one or more design rules from the set of design rules.

25. The system according to claim 22, wherein:
the image analyzer is arranged to obtain a set of fixed duration weighted maps for a current playback time code +n frames for a set of n values, wherein n is an integer between 0 and a value corresponding to a difference between a buffer duration and a desired duration of the insertable image content, such that each of the set of fixed duration weighted maps has a corresponding n value;
the rules data store further comprises:
a set of graphic options, and
a set of placement options for the insertable image content; and
the system further comprises:
a score calculator arranged to calculate one or more second scores relating to one or more combinations of: a graphic option from the set of graphic options, a placement option from the set of placement options, or one or more n values,
a placement decision maker arranged to select which one of the one or more combinations should be used, based on the one or more second scores, and
a trigger creator arranged to trigger the placement of the insertable image content by the graphic placer at a time code corresponding to the current playback time code +n frames in accordance with the selected combination.
